(19) United States
(12) Patent Application Publication
(10) Pub. No.: US 2008/0120614 A1
(43) Pub. Date: May 22, 2008

(54) Device, Method, and Computer Usable Medium for Installing Programs

(75) Inventor: Takafumi Yamada, Nagoya (JP)

Correspondence Address: BANNER & WITCOFF, LTD.;ATTORNEYS FOR CLIENT NOS. 0166889, 006760, 1100 13th STREET, N.W., SUITE 1200, WASHINGTON, DC, 20005-4051, US

(73) Assignee: BROTHER KOGYO KABUSHIKI KAISHA, Nagoya (JP)

(21) Appl. No.: 11/943,311

(22) Filed: Nov. 20, 2007

(30) Foreign Application Priority Data
Nov. 21, 2006 (JP) 2006-313848
Nov. 6, 2007 (JP) 2007-288044

(51) Int. Cl. G06F 9/445

(52) U.S. Cl. 717/175

(57) ABSTRACT

A program installable device capable of setting up a plurality of programs therein is provided. The device includes an installing system to install the plurality of programs time-divisionally at least partially in parallel, an initial configuration setting system to set a predetermined program among the plurality of programs in an initial configuration during an installing operation of the predetermined program, an installation detecting system to detect one of completion and incompletion of the installing operation of the predetermined program, an initial configuration obtaining system to obtain the initial configuration of the predetermined program when completion of the installing operation of the predetermined program is detected, and an initial configuration reflecting system to reflect the initial configuration of the predetermined program into remaining of the plurality of programs so that the initial configuration of the predetermined program is reflected into initial configurations of the remaining programs during the installation.

### CROSS REFERENCE TO RELATED APPLICATION

This application claims priority from Japanese Patent Applications No. 2006-313848, filed on Nov. 21, 2006, and No. 2007-288044, filed on Nov. 6, 2007, the entire subject matters of which are incorporated herein by reference.

### BACKGROUND

1. Technical Field

Aspects of the present invention relate to a device and a method for installing a plurality of computer programs.

2. Related Art

Conventionally, a device for installing a plurality of computer programs within an application software package has been suggested. Such computer programs include a plurality of component programs. For example, when a device driver for a printing device is referred to as the computer program, a printer status monitor to monitor operational status of the printer, a printer driver to control operations of the printer, a document file including information to a user concerning the operations of the printer, a utility program, which is a supplemental program to improve operability of the printer driver, can be referred to as components programs to configure the device driver.

In an installing device disclosed in Japanese Patent Provisional Publication 2004-38533, for example, a user is provided with installing options, which are full installation, optional installation, and custom installation, and program components corresponding to the selected installing method are installed in the device.

When the full installation is selected, entire programs and parameters being provided in the software package are installed regardless of the user's preferences for the application software. In this regard, the software programs are configured with predetermined initial parameter values. When the optional installation is selected, programs and parameters exclusively necessary for a specific use of the application program according to the user's preference are installed. In this regard, the programs are configured with predetermined initial parameter values. When the custom installation is selected, programs and parameters desired by the user are exclusively installed as an initial configuration. In this regard, the programs are configured with parameter values which are specified by the user.

### SUMMARY

Thus, the in the conventional installation methods, parameter values according to the usage of the application software are set in the device upon installation. However, in the conventional installing methods, the installing processes to install a plurality of components are conducted serially, therefore, it causes long waiting time during the installation. Further, the programs are required to be set in the initial parameter values to initialize the configuration thereof in each installing operation.

In view of the above problems, the present invention is advantageous in that a program installable device capable of installing a plurality of programs in shorter time is provided.

An aspect of the present invention is advantageous in that a program installable device capable of setting up a plurality of programs therein is provided. The device includes an installing system to install the plurality of programs time-divisionally at least partially in parallel, an initial configuration setting system to set a predetermined program among the plurality of programs in an initial configuration during an installing operation of the predetermined program being installed by the installing system, an installation detecting system to detect one of completion and incompletion of the installing operation of the predetermined program, an initial configuration obtaining system to obtain the initial configuration of the predetermined program set by the initial configuration setting system when completion of the installing operation of the predetermined program is detected by the installation detecting system, and an initial configuration reflecting system to reflect the initial configuration of the predetermined program obtained by the initial configuration obtaining system into remaining of the plurality of programs so that the initial configuration of the predetermined program is reflected into initial configurations of the remaining programs during the installation.

According to another aspect of the invention, there is provided a method to set up a plurality of programs in a computer, including steps of installing the plurality of programs time-divisionally at least partially in parallel, setting a predetermined program among the plurality of programs in an initial configuration during an installing operation of the predetermined program being installed, detecting one of completion and incompletion of the installing operation of the predetermined program, obtaining the initial configuration of the predetermined program set in the initial configuration setting step when completion of the installing operation of the predetermined program is detected in the installation detecting step, and reflecting the initial configuration of the predetermined program obtained in the initial configuration obtaining step into remaining of the plurality of programs so that the initial configuration of the predetermined program is reflected into initial configurations of the remaining programs during the installation.

According to still another aspect of the invention, there is provided a computer usable medium having computer readable instructions for controlling a computer to set up a plurality of programs therein by executing steps of installing the plurality of programs time-divisionally at least partially in parallel, setting a predetermined program among the plurality of programs in an initial configuration during an installing operation of the predetermined program being installed, detecting one of completion and incompletion of the installing operation of the predetermined program, obtaining the initial configuration of the predetermined program set in the initial configuration setting step when completion of the installing operation of the predetermined program is detected in the installation detecting step, and reflecting the initial configuration of the predetermined program obtained in the initial configuration obtaining step into remaining of the plurality of programs so that the initial configuration of the predetermined program is reflected into initial configurations of the remaining programs during the installation.

According to the above configurations, a time period required to install the predetermined program along with the remaining programs can be shortened, particularly compared to a configuration wherein the programs are serially installed and each of the remaining programs is configured with the initial configuration values upon installation.

### BRIEF DESCRIPTION OF THE ACCOMPANYING DRAWINGS

FIG. 1 is a schematic illustration of a hardware configuration of a program installable device according to an embodiment of the present invention.

FIG. 2 is a block diagram to illustrate a functional configuration of the program installable device according to the embodiment of the present invention.

FIG. 3 is a flowchart to illustrate a main program of an installer program according to the embodiment of the present invention.

FIG. 4 is a schematic view of a selection window, in which installation components to be installed are specified, according to the embodiment of the present invention.

FIG. 5 is a flowchart to illustrate a printer driver installer program according to the embodiment of the present invention.

FIG. 6 is a flowchart to illustrate a monitoring program according to the embodiment of the present invention.

FIG. 7 is a flowchart to illustrate a sub-flow of the main program of the installer program according to the embodiment of the present invention.

FIGS. 8A and 8B illustrate comparison in processing time in installation between a conventional program installable device and the program installable device according to the embodiment of the present invention.

### DETAILED DESCRIPTION

Hereinafter, referring to accompanying drawings, embodiments of the present invention will be described.

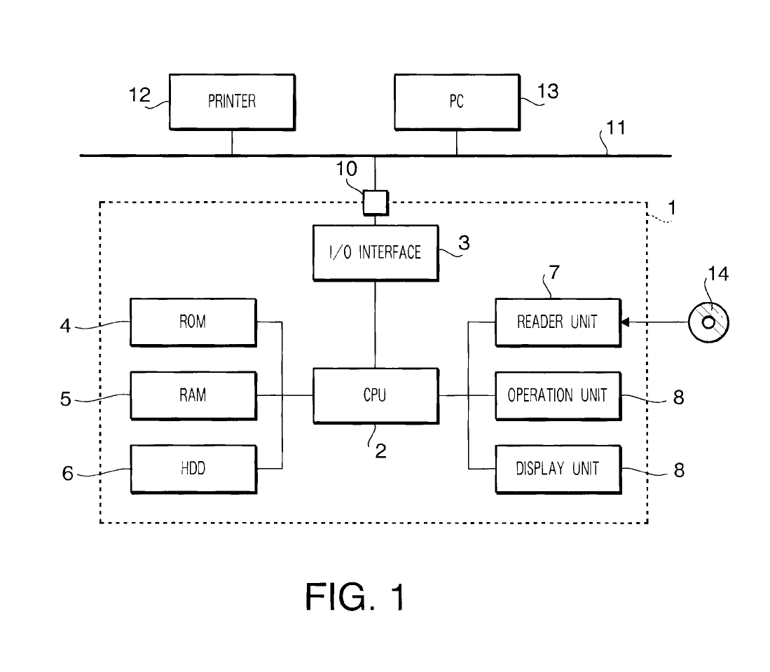

FIG. 1 is a schematic illustration of a hardware configuration of a program installable device 1 according to an embodiment of the present invention. The program installable device 1 according to the embodiment of the present invention can be configured with a known personal computer (hereinafter referred to as a PC 1.) The PC 1 includes a CPU 2, an I/O (input/output) interface 3, a ROM (read only memory), a RAM (random access memory) 5, and an HDD (hard disk drive) 6, which are directly/indirectly connected with one another. Further, the CPU 2 is connected with a reader unit 7, an operation unit 8, and a display unit 9.

The CPU 2 controls the entire operations of the PC 1 and computes various data. The I/O interface 3 is connected to a LAN (local area network) 11 through an I/O port 10 so that various data can be exchanged with external devices such as a printer 12 and a PC 13. The ROM 4 is a read only nonvolatile memory, in which various data and programs are stored. The RAM 5 is a readable and writable volatile memory, in which various data and programs are temporarily stored when a program is run. The HDD 6 is a storage unit to store various data and programs.

The reader unit 7 reads out various data and programs from an external memory medium, such as a CD-ROM 14 and a floppy disk (registered trademark). The operation unit 8 is operated by a user for inputting various data and includes a keyboard and a mouse (not shown). The display unit 9 outputs various information to be displayed and includes an LCD (liquid crystal display).

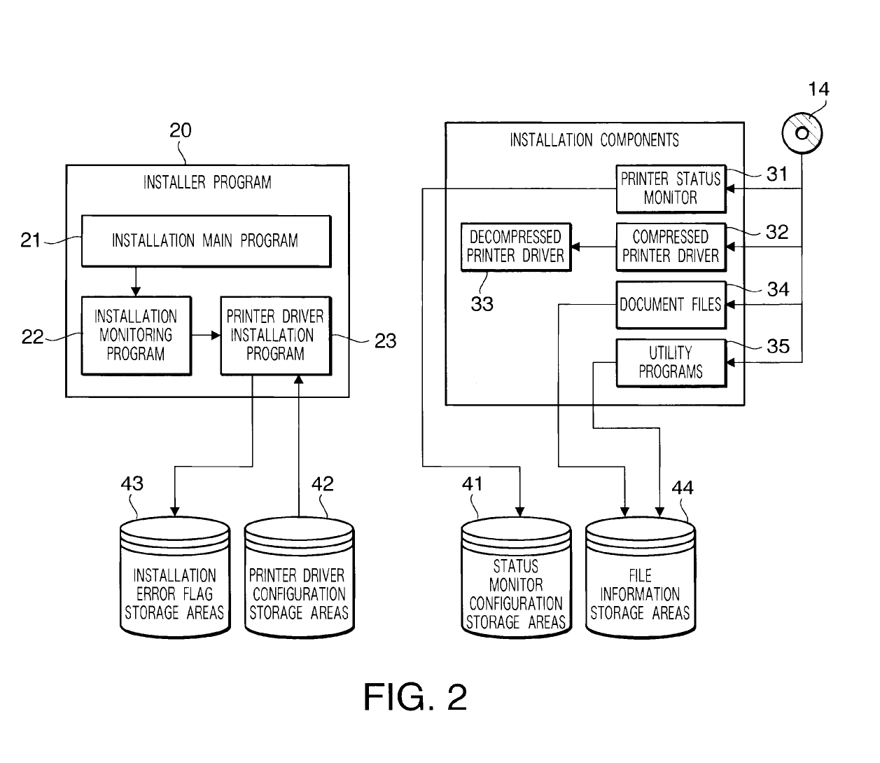

Next, a functional configuration of the PC 1 according to the embodiment of the present invention is descried. FIG. 2 is a block diagram to illustrate the functional configuration of the PC 1 according to the embodiment of the present invention. Upon installation of a new program, i.e., a printer driver in the present embodiment, the PC 1 runs installer programs 20, which are stored in the HDD 6, and obtains installation components from the external memory medium to copy and store the same in the HDD 6.

The installation components to configure the printer driver, stored in the external memory medium (i.e., the CD-ROM 14 in the present embodiment) and copied to be stored in the HDD 6 of the PC 1, include a printer status monitor 31, a compressed printer driver 32, document files 34, and utility programs 35.

The printer status monitor 31 is a program to be run to monitor operational status of the printer 12. The printer driver 32 to control the operations of the printer 12 is compressed to be stored in the CD-ROM 14 and obtained therefrom to be stored in the HDD 6. The document files 34 are electric files, which include data to represent user instructions concerning the operation of the printer 12. The utility programs 35 are supplemental programs to improve operability of the printer driver.

The installer programs 20 according to the present embodiment include an installation main program 21, an installation monitoring program 22, and a printer driver installer program 23.

The installation main program 21 controls a plurality of programs in parallel to install the new printer driver (i.e., a decompressed printer driver 33, of which detail will be described later). The installation monitoring program 22 monitors installing status of the printer driver being installed. Further, the installation monitoring program 22 casts initial configuration of the printer driver according to a consequent (i.e., status) of the installation into the other installation components to be run in cooperation with the printer driver. The printer driver installer program 23 controls installing operations of the printer driver.

In addition to the above, the HDD 6 is provided with a plurality of storage areas, which are a status monitor configuration storage area 41, a printer driver configuration storage area 42, an installation error flag storage area 43, and a file information storage area 44.

In the status monitor configuration storage area 41, parameters for the printer status monitor 31 are stored. In the printer driver configuration storage area 42, initial parameters for the PC 1, which are set upon the installation of the decompressed printer driver 33, are stored. In the installation error flag storage area 43, an error flag to indicate as to whether the installation was successful or failed is stored. In the file information storage area 44, information concerning the decompressed printer driver 33 such as the document files 34 and the utility programs 35 is stored.

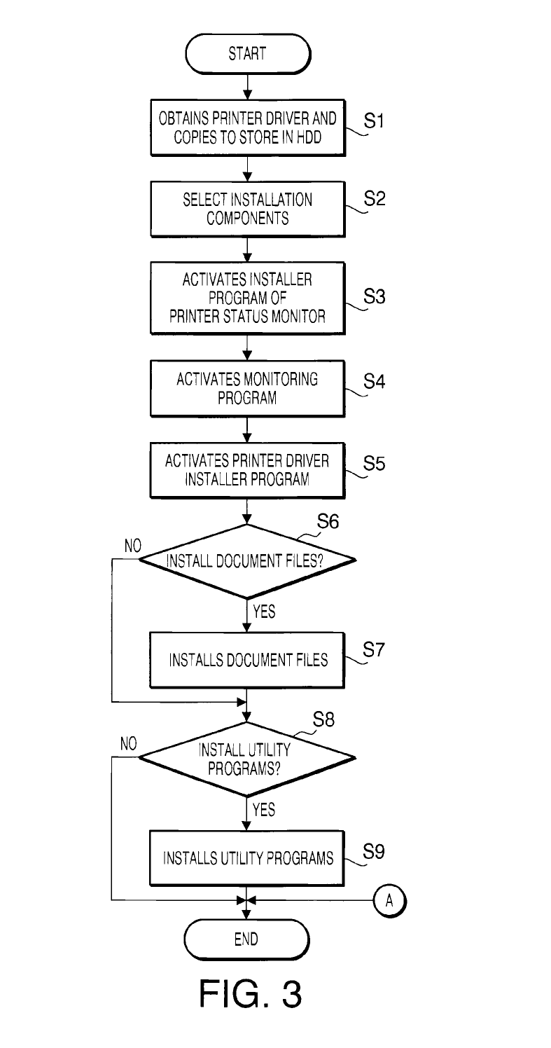

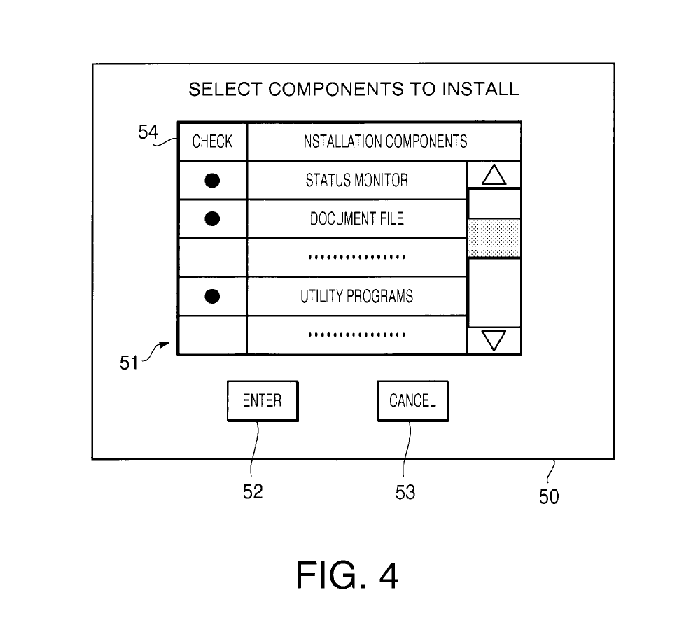

Hereinafter, operations of the installation main program 21 will be described. FIG. 3 is a flowchart to illustrate the installation main program 21 of the installer program 20 according to the embodiment of the present invention. FIG. 4 is a schematic view of a selection window 50, in which installation components to be installed are specified, according to the embodiment of the present invention.

In the present embodiment, the installation main program 21 as shown in FIG. 3 is activated upon an instruction from a user to install the printer driver. More specifically, the CPU 2 of the PC 1 controls the display unit 9 to display a window in which the user inputs an instruction to install the printer driver when, for example, the reader unit 7 reads the information stored in the CD-ROM 14. When the user inputs the instruction through the operation unit 8 according to the display, signals representing the input triggers the CPU 2 to obtains and copies the installation main program 21 from the HDD 6 to store in the RAM 5.

When the installation main program 21 starts, in S1, the CPU 2 obtains the printer driver stored in the CD-ROM 14 to store in the HDD 6. More specifically, the compressed printer driver 32 stored in the CD-ROM 14 is read by the reader unit 7 and copied to be stored in the HDD 6.

Thereafter, in S2, the components to be installed are selected. In the present embodiment, for example, the selection window 50 having a list 51 of the installation components, an enter button 52, and a cancel button 53 is displayed in the display unit 9. The list 51 includes checkboxes 54, each of which corresponds to the installable component. The user operates the operation unit 8 to place a checkmark (a dot) in the checkbox 54 corresponding to the desired installation component and presses the enter button 52. When no installation component is desired to be installed, the user leaves the checkboxes unchecked and presses the enter button 52. The CPU 2 judges that the selection of the installation components is complete and proceed to S3.

Thus, in the present embodiment, the selection window 50 notifies the user of the optionally installable components. In addition, the selection window 50 also notifies the user of the installation components to be compulsorily installed. Therefore, since the status monitor 31 is compulsorily installed in the present embodiment, in the selection window 50, the status monitor 31 is indicated such that the checkmark thereof is not removable so that the user cannot cancel installation of the status monitor 31.

In S3, an installer program of the printer status monitor 31 is activated. During the installation, the printer status monitor 31 stored in the CD-ROM 14 is read by the reader unit 7 and stored in the HDD 6. Thereafter, in S4, the installation monitoring program 22, of which details will be described later, is activated. Thus, the installation monitoring program 22 and the installation main program 21 are simultaneously run time-divisionally in parallel.

In S5, the printer driver installer program 23, of which details will be described later, is activated. Thus, the printer driver installer program 23, the installation monitoring program 22 and the installation main program 21 are simultaneously run time-divisionally in parallel.

In S6, it is judged as to whether it is required to install the document files 34. In the present embodiment, the judgment is made based on the checkmark (dot) placed in the checkbox 54 indicating the document files 34 in the list 51. If no checkmark is placed in the checkbox 54, it is judged that no document file 34 is to be installed (S6: NO). The process proceeds to S8.

In S6, if the checkmark has been placed in the checkbox 54 corresponding to the document files 34, it is judged that the document files 34 require to be installed (S6: YES). Accordingly, in S7, the document files 34 are installed, and the process proceeds to S8.

In S8, it is judged as to whether it is required to install the utility programs 35. In the present embodiment, the judgment is made based on the checkmark (dot) placed in the checkbox 54 indicating the utility programs 35 in the list 51. If no checkmark is placed in the checkbox 54, it is judged that no utility program 35 is to be installed (S8: NO). Thereafter, the process is terminated.

In S8, if the checkmark has been placed in the checkbox 54 indicating the utility programs 35, it is judged that the utility programs require to be installed (S8: YES). Accordingly, in S9, the utility programs 35 are installed, and the process is terminated. Thus, when the installation main program 21 is run, the desired installation components such as the document files 34 and the utility programs 35 as well as the printer status monitor 31 are installed in the HDD 6.

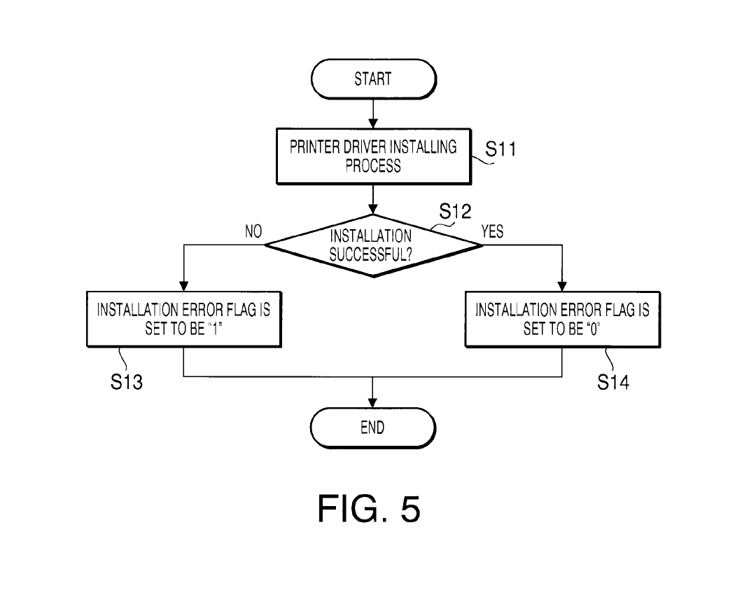

Next, a process to be executed in the printer driver installer program 23 will be described. FIG. 5 is a flowchart to illustrate the process of the printer driver installer program 23 according to the embodiment of the present invention. The printer driver installer program 23 is activated by activating signals generated in the installation main program 21 (see S3 in FIG. 3).

When the printer driver installer program 23 runs, in S11, the compressed printer driver 32, which was copied to be stored in the HDD 6 in S1 in FIG. 3, is decompressed and stored in the HDD 6 as the decompressed printer driver 33. Further, in this step, initial configuration for the printer 12 is obtained from the CD-ROM 14 and stored in the printer driver configuration storage area 42 of the HDD 6.

Thereafter, in S12, it is judged as to whether the installation of the printer driver is successful. More specifically, it is judged as to whether the decompressed printer driver 33 is copied and stored in the HDD 6 completely and as to whether the printer driver has been registered in the PC 1.

If copying and storing the decompressed printer driver 33 did not complete due to an error during the copying operation or the storing operation, it is judged that the installation failed (S12: NO). Thereafter, in S13, an error flag for the printer driver installation is set to be “1”, i.e., “1” is stored in the installation error flag storage area 43 of the HDD 6. The process terminates thereafter.

In S12, if copying and storing the decompressed printer driver 33 completed, it is judged that the installation was successful (S12: YES). In S14, the error flag for the printer driver installation is set to be “0”, i.e., “0” is stored in the installation error flag storage area 43 of the HDD 6. The process terminates thereafter.

Thus, when the printer driver installer program 23 is run, the decompressed printer driver 33 can be installed in the HDD 6. Further, installation status (whether successful or failed) of the decompressed printer driver 33 can be recognized by referring to the installation error flag storage area 43.

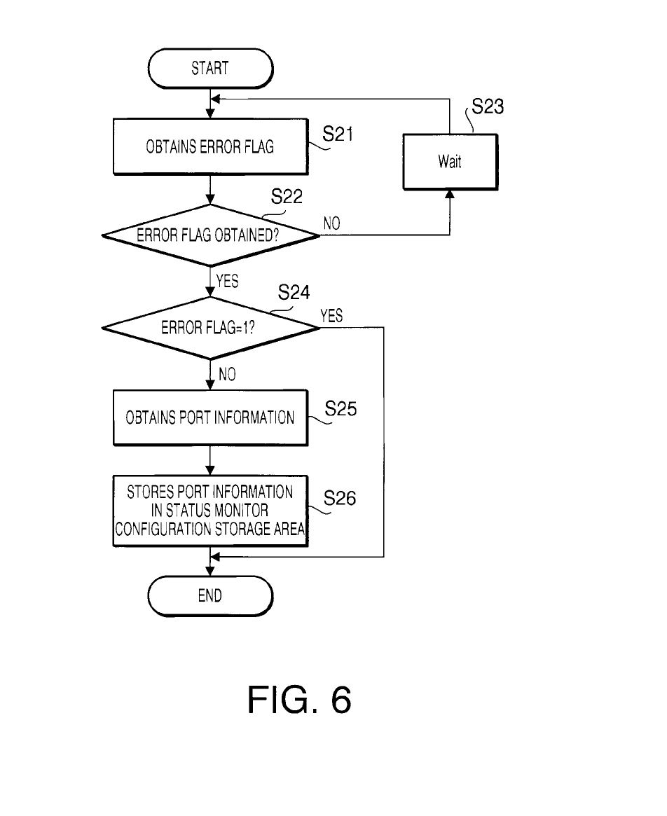

Next, a process to be executed in the installation monitoring program 22 will be described. FIG. 6 is a flowchart to illustrate the installation monitoring program 22 according to the embodiment of the present invention. The installation monitoring program 22 is activated by activating signals generated in the installation main program 21 (see S4 in FIG. 3).

When the installation monitoring program 22 runs, in S21, the CPU 2 obtains the error flag, i.e., the CPU 2 attempts to obtain the value stored in the installation error flag storage area 43. Thereafter, in S21, it is judged as to whether the error flag is obtained.

It is noted that, when the installation of the printer driver is incomplete, no value is stored in the installation error flag storage area 43. Thus, in S22, it is judged that the error flag is not obtained from the installation error flag storage area 43 (S22: NO). Thereafter, in S23, the CPU 2 waits until a value is stored in the installation error flag storage area 43.

When the value in the installation error flag storage area 43 was obtained (S22: YES), in S24, it is judged as to whether the obtained value is “1.” If the value is “1” (S24: YES) it indicates that the installation of the decompressed printer driver 33 failed, therefore, the initial configuration of the printer driver 33 obtained in the printer driver installing process (S11 in FIG. 5) is not reflected into the other programs to be run in cooperation with the printer driver 33. Therefore, the process is terminated without executing any further step.

In S24, if the value obtained from the installation error flag storage area 43 is “0”, it is judged that the installation of the decompressed printer driver 33 was successful. Accordingly, in S25, information regarding the I/O port 10 is obtained. In the present embodiment, information to identify the I/O port 10 (port information) which is used to transmit data from the PC 1 to the printer 12 is read from the printer driver configuration storage area 42 and copied to be stored in the RAM 5. Thus, the information regarding the I/O port 10 as an option of the initial configuration of the decompressed printer driver 33 is obtained based on the installation result (i.e., successful or failed) of the decompressed printer driver 33.

Further, in S26, the port information copied and stored in the RAM 5 is stored in the status monitor configuration storage area 41. That is, the port information of the I/O port 10 which is to be used in cooperation with the decompressed printer driver 33 is reflected to be the initial configuration of the printer status monitor 31.

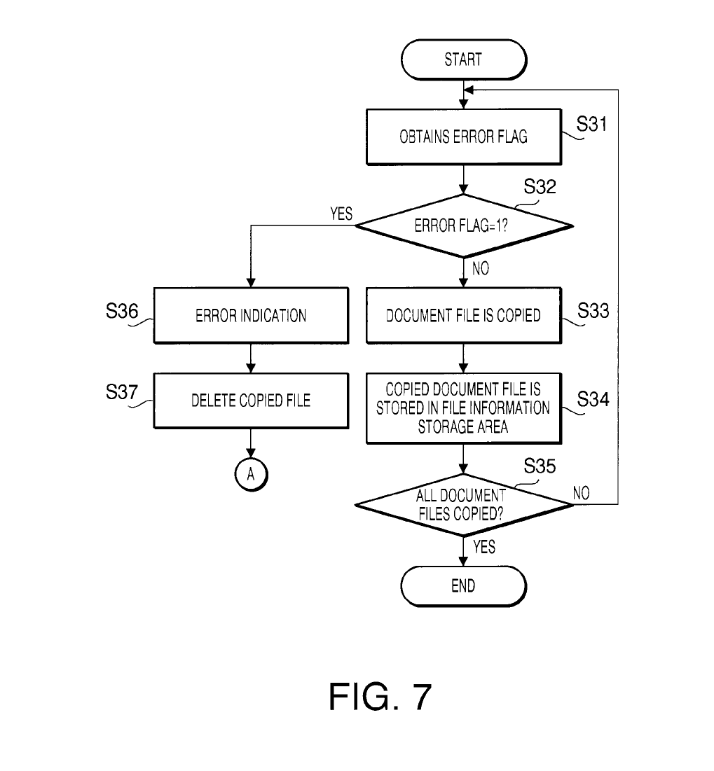

Next, a component installation process will be described in detail. The component installation process is executed, according to the present embodiment, when the installation components specified by the user in S2 (see FIG. 3) are installed in S7 and in S9 in FIG. 3. FIG. 7 is a flowchart to illustrate the document file installation process according to the embodiment of the present invention. It should be noted that the utility program installation process, in which utility programs specified by the user in S9 in FIG. 3 are installed through, can be executed similarly to the document file installation process through the following steps. Therefore, description of the utility program installation process is omitted herein.

When the component installation process starts, in S31, the CPU 2 obtains the error flag, i.e., the CPU 2 obtains the value stored in the installation error flag storage area 43 and copies the value to store in the RAM 5. Further, in S32, it is judged as to whether the obtained value indicating the error flag is “1.”

In S32, if the value indicating the error flag is “0” (S32: NO) in S33, the document file is copied, i.e., one of document files 34 stored in the CD-ROM 14 is read by the reader unit 7 and copied to be stored in the HDD 6. Thereafter, in S34, the copied document file 34 is stored in the file information storage area 44. Thus, one of the document files 34 originally stored in the CD-ROM 14 is installed in the PC 1.

In S35, it is judged as to whether all of the document files 34 in the CD-ROM 14 are stored in the file information storage area 44. When a plurality of document files 34 are stored in the CD-ROM 14, and there is at least one remaining document file 34 (S35: NO) the process returns to S31. A next document file 34 is copied to be stored in the HDD 6.

Thus, the steps S31-S35 are repeated to complete copying and storing all of the document files 34. In S35, if it is judged that all of the document files 34 are stored (S35: YES) the process is terminated.

In S32, if the value indicating the error flag is “1” (S32: YES) it refers to the installation of the printer driver failed. Therefore, the printer driver is not usable, i.e., the copied file information is also unusable. Accordingly, in S36, an error message to notify the user of the installation error is displayed in the display unit 9. The error message may be, for example, “Installation of the printer driver failed. Please try to install from the start.”

Thereafter, in S37, the document files 34 copied and stored in the HDD 6 (in S33) and the file information storage area 44 (in S34) are deleted. Thus, the document files 34, which have been installed in the components installation process are deleted so that storing the identical document files 34 redundantly in the HDD 6 to waste the storage area can be prevented.

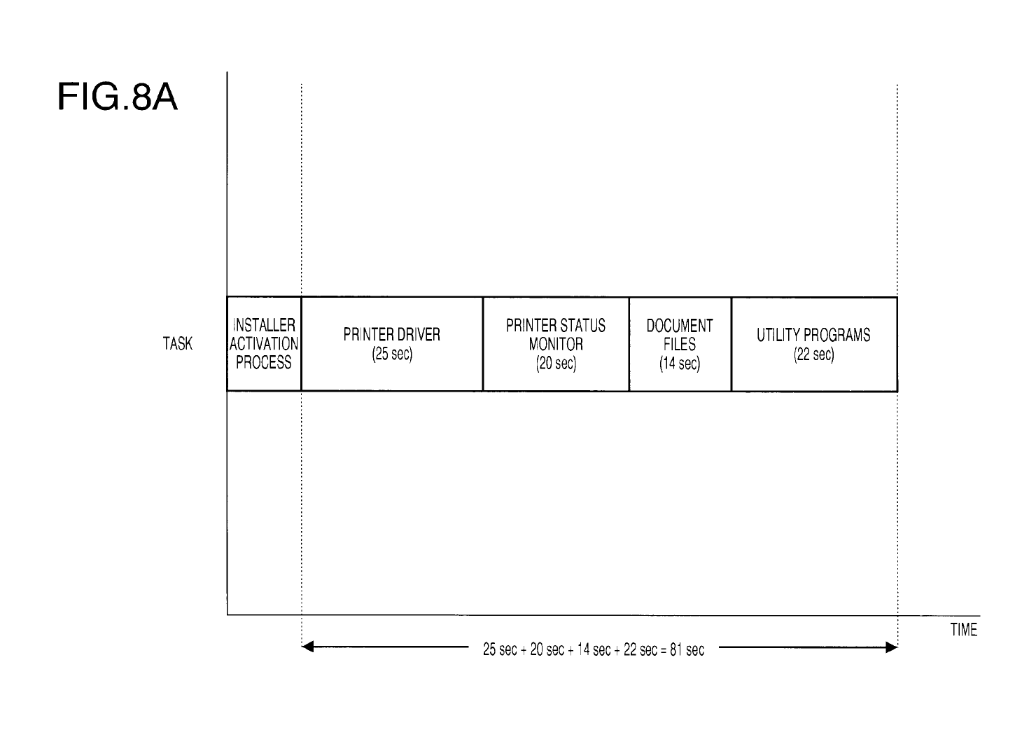

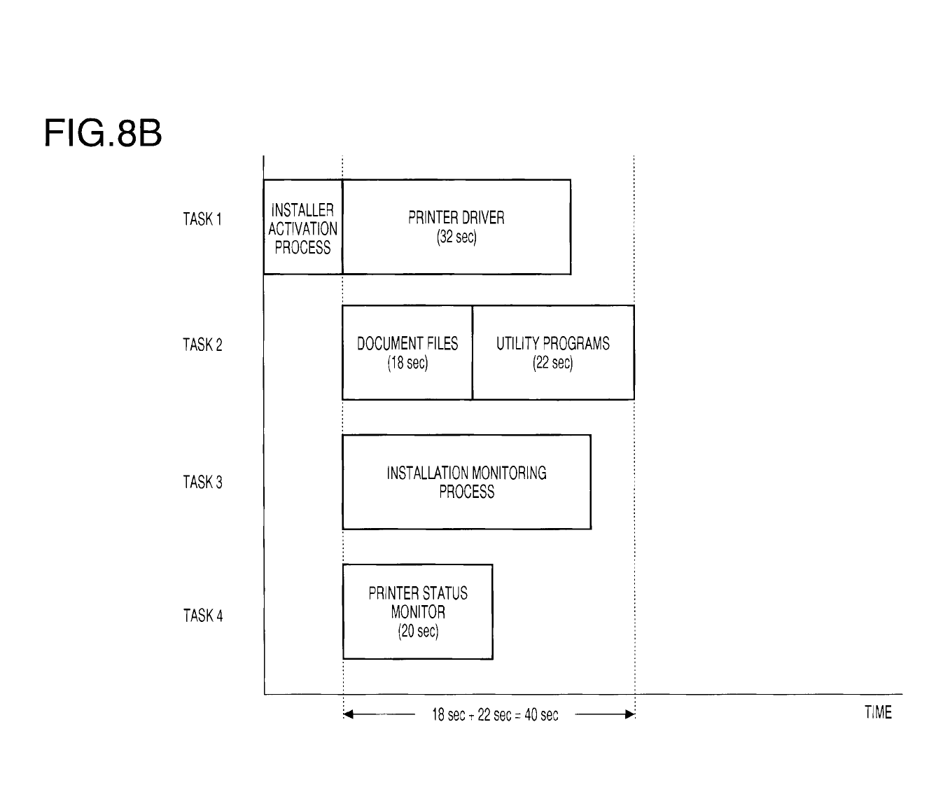

As thus far described above, according to the PC 1 of the present embodiment, the installation of the installation components (i.e., the document files 34 and the utility programs 35), the installation monitoring program 22, and the printer driver installer program 23 are performed substantially simultaneously time-divisionally in parallel (see FIGS. 3, 5, and 6). Particularly, the printer status monitor 31, the decompressed printer driver 33, the document files 34, and the utility programs 35 are installed in parallel in time series. FIG. 8B schematically illustrates the installation process, in which the plurality of installer programs are run in parallel.

Further, the port information of the I/O port 10, which is used to transmit data to the printer 12 is obtained and stored in the status monitor configuration storage area 41 so that the port information can be reflected to be the initial configuration of the printer status monitor 31 (see S25, S26 in FIG. 6).

According to the above configuration, a time period required to install the printer driver 33 can be shortened, particularly compared to a configuration wherein the printer driver 33, the printer status monitor 31, the document files 34, and the utility programs 35 are serially installed. FIG. 8A schematically illustrates the installation process, in which the plurality of installer programs are serially run. FIG. 8B schematically illustrates the installation process, in which the plurality of installer programs are run in parallel. In FIGS. 8A and 8B, it is noted that the installer activation process represents the steps S1-S2 shown in FIG. 3. These steps are common between the conventional installation process (shown in FIG. 8A) and the installation process in the present embodiment (shown in FIG. 8B.) Therefore, description for the time periods being required in these steps is omitted herein.

As shown in FIG. 8A, when the plurality of programs are serially run, in an experimental measurement, installation of the printer driver 33, the printer status monitor 31, the document files 34, and the utility programs 35 required 25 seconds, 20 seconds, 14 seconds, and 22 seconds respectively. In total, 81 seconds was required for the installation.

On the contrary, as shown in FIG. 8B, when the plurality of programs are run in parallel in the PC 1 according to the present embodiment, installation of the printer driver 33, the document files 34, the utility programs 35, and the printer status monitor 31 required 32 seconds, 18 seconds, 22 seconds, and 20 seconds respectively. It is noted that in this configuration, the individual steps in each installation process being run in parallel is performed one by one in turn by the CPU 2, and installations of the printer driver 33 and the document files 34 require longer time periods than the process time periods of those in the serial installation.

The order of the installation of the programs is not limited to the order as described above. However, in order for the printer status monitor 31 to be activated, the port information of the I/O port 10, which is to be used in cooperation with the printer driver 33, needs to be obtained from the status monitor configuration storage area 41, and the port information becomes available when the installation of the printer driver 33 is completed.

Therefore, the installation main program 21 activates the installation monitoring program 22 after installing the printer status monitor 31. Thus, the activated installation monitoring program 22 starts monitoring installation status of the printer driver 33 to detect a point in which the installation of the printer driver 33 is completed and the port information becomes available. The installation main program 21 thereafter activates the printer driver installer program 23 to install the printer driver 33. Further, the installation main program 21 installs the document files 34 and the utility programs 35 in the interim to utilize the periods unoccupied from the installation of the printer driver 33.

Meanwhile, when the port information becomes available after completion of the installation of the printer driver 33, the installation monitoring program 22 obtains the port information to store in the status monitor configuration storage area 41.

In the parallel installation as shown in FIG. 8B, the individual steps in each installation process are effectively run in unoccupied periods. Therefore, the printer status monitor 31, the document files 34, and the utility programs 35 can be installed concurrently while the decompressed printer driver 33 is being installed.

Therefore, the total time period of installation for the decompressed printer driver 33, the printer status monitor 31, the document files 34, and the utility programs 35 is included in 40 seconds, which is the sum of installation of the document files (i.e., 18 seconds) and the utility programs (i.e., 22 seconds.)

Thus, the 40 seconds for the parallel installation is shorter for 41 seconds than the 81 seconds (i.e., approximately ½) in the serial installation as shown in FIG. 8A. It is noted that in many cases that the users stand by at the PC 1 to wait for the completion of installation of a program. In such cases, it is notably efficient in time to shorten the installation time for 41 seconds.

In the above comparison between the serial installation and the parallel installation, processing time required for the installer activation process is eliminated. The installer activation process includes a user-oriented step, i.e., S2 (see FIG. 3) in which the user selects components to be installed. It is noted that the process time for this user-oriented step can vary in a wide range, regardless of the installing method, depending on the user and the environment surrounding the user. Therefore, the processing time for the installer activation process is eliminated from the comparison.

In the present embodiment, as described above, the values as the initial configuration of the decompressed printer driver 33 to be set in the PC 1 are obtained and automatically reflected into the configuration of the printer status monitor 31 (S25, S26 in FIG. 6) while the printer status monitor 31, the decompressed printer driver 33, the document files 34, and the utility programs 35 are being installed according to the installation main program 21, the installation monitoring program 22, and the printer driver installer program 23. Therefore, the printer status monitor 31 can be usably and efficiently configured.

According to the above configuration, initial values to be set in the printer driver 33 are obtained based on the information regarding the I/O port 10 to be used for data transmission to the printer 12. Therefore, the user is not required to input the information regarding the I/O port 10 to configure the printer status monitor when the I/O port 10 is used for the data transmission. Thus, usability of the PC 1 can be improved.

Although an example of carrying out the invention have been described, those skilled in the art will appreciate that there are numerous variations and permutations of the program installable device that falls within the spirit and scope of the invention as set forth in the appended claims. It is to be understood that the subject matter defined in the appended claims is not necessarily limited to the specific features or act described above. Rather, the specific features and acts described above are disclosed as example forms of implementing the claims.

For example, it is noted that the storage of the installation main program 21, the installation monitoring program 22, and the printer driver installer program 23 is not limited to the CD-ROM 14, but can be a storage unit provided in the program installable device such as the ROM 4 and the HDD 6 or any other external storage medium such as a floppy disk (registered trademark.)

For another example, the program installable device for a program is not limited to the PC 1 as long as the device is capable of installing a program therein. Further, the program to be installed is not limited to the printer driver 33, but may be programs concerning operations of an external device to be connected with the PC 1 and programs concerning a software programs, such as an upgrading program for an operating system.

What is claimed is:

1. A program installable device capable of setting up a plurality of programs therein, comprising:
an installing system to install the plurality of programs time-divisionally at least partially in parallel;
an initial configuration setting system to set a predetermined program among the plurality of programs in an initial configuration during an installing operation of the predetermined program being installed by the installing system;
an installation detecting system to detect one of completion and incompletion of the installing operation of the predetermined program;
an initial configuration obtaining system to obtain the initial configuration of the predetermined program set by the initial configuration setting system when completion of the installing operation of the predetermined program is detected by the installation detecting system; and
an initial configuration reflecting system to reflect the initial configuration of the predetermined program obtained by the initial configuration obtaining system into remaining of the plurality of programs so that the initial configuration of the predetermined program is reflected into initial configurations of the remaining programs during the installation.

2. The program installable device according to claim 1,
wherein the predetermined program is a device driver program, and
wherein the remaining programs are component programs.

3. The program installable device according to claim 1,
wherein the initial configuration of the predetermined program includes information concerning a data port to be used for data exchange between the program installable device and an external device.

4. A method to set up a plurality of programs in a computer, comprising steps of:
installing the plurality of programs time-divisionally at least partially in parallel;
setting a predetermined program among the plurality of programs in an initial configuration during an installing operation of the predetermined program being installed;
detecting one of completion and incompletion of the installing operation of the predetermined program;
obtaining the initial configuration of the predetermined program set in the initial configuration setting step when completion of the installing operation of the predetermined program is detected in the installation detecting step; and
reflecting the initial configuration of the predetermined program obtained in the initial configuration obtaining step into remaining of the plurality of programs so that the initial configuration of the predetermined program is reflected into initial configurations of the remaining programs during the installation.

5. The method according to claim 4,
wherein the predetermined program is a device driver program, and
wherein the remaining programs are component programs.

6. The method according to claim 4,
wherein the initial configuration of the predetermined program includes information concerning a data port to be used for data exchange between the program installable device and an external device.

7. A computer usable medium comprising computer readable instructions for controlling a computer to set up a plurality of programs therein by executing steps of:
installing the plurality of programs time-divisionally at least partially in parallel;
setting a predetermined program among the plurality of programs in an initial configuration during an installing operation of the predetermined program being installed;
detecting one of completion and incompletion of the installing operation of the predetermined program;
obtaining the initial configuration of the predetermined program set in the initial configuration setting step when completion of the installing operation of the predetermined program is detected in the installation detecting step; and
reflecting the initial configuration of the predetermined program obtained in the initial configuration obtaining step into remaining of the plurality of programs so that the initial configuration of the predetermined program is reflected into initial configurations of the remaining programs during the installation.
